(19) United States
(12) Patent Application Publication
(10) Pub. No.: US 2025/0340068 A1
(43) Pub. Date: Nov. 6, 2025

(54) Autonomous Marking System and Method

(71) Applicant: 10Lines OÜ, Tallinn (EE)

(72) Inventors: Janno Paas, Tallinn (EE); Tarmo Prints, Tallinn (EE)

(21) Appl. No.: 18/868,072

(22) PCT Filed: May 22, 2023
(86) PCT No.: PCT/EP2023/063669

§ 371 Date: Nov. 21, 2024

(30) Foreign Application Priority Data
May 25, 2022 (EP) 22175499.7

(51) Int. Cl. B41J 3/407; B41J 3/44; B41J 25/00; B41J 25/308; B41J 29/393; E01C 23/01; E01C 23/22; E01F 9/518; G05D 1/672; G05D 101/00; G05D 105/00; G06T 7/00

(52) U.S. Cl. CPC B41J 3/407; B41J 3/445; B41J 25/001; B41J 25/308; B41J 29/393; E01C 23/01; E01C 23/222; E01F 9/518; G05D 1/672; G06T 7/0004; G05D 2101/22; G05D 2105/17; G06T 2207/30144

(57) ABSTRACT

A robot for autonomous marking of a marking area includes: a robot communication system configured to at least receive a marking information data element from a remote component, and a controlling component configured to control the robot based, at least in part, on the marking information data element. A remote component includes a remote communication unit, wherein the remote component is configured to communicate, by the remote communication unit, with the autonomous robot for marking a marking area. A method and system for autonomous marking of a marking area includes the robot and the remote component, wherein: the remote component is configured to generate a marking information data element based on marking data, the remote component is configured to send the marking information data element to the robot, and the robot is configured to mark the marking area based on the marking information data element.

### FIELD

The present invention relates generally to the field of autonomous marking. More particularly, it relates to a system and a method for conducting marking work with an autonomous robot for outdoor and indoor use.

### BACKGROUND

Marking of marking areas such as parking lots or warehouse compounds is known to be manual and time-consuming work. The layout and the marking are usually individual tasks and depend on the space and conditions available. Typically, marking areas have to be pre-marked, over which markings are made, that may require a number of measurements and/or calculations to be made. The combination of measurement and calculation may be time-consuming and prone to errors. As a consequence, re-marking is frequently resorted to. Further, the striping machines used currently generally comprise gasoline-based engines and their use may be detrimental to the environment.

DK 201870263 A1 relates to a method for marking a ground surface according to a predefined marking pattern using a system comprising a robot unit and a local base station comprising acts of providing two flag points, receiving global positioning data of the robot unit using a robot GNSS receiver, receiving global positioning data of the local base station using a base GNSS receiver, and establishing a local base station position using the received global positioning data of the local base station. The invention relates furthermore to a system for marking a ground surface according to a predefined marking pattern and the use thereof or parts thereof.

U.S. Ser. No. 16/632,944 discloses a line marking device comprising a cart with at least one steerable wheel and at least two moving elements. The steerable wheel is rotatable around its axle and pivotable such that the cart is steered in a desired direction. The line marking device comprises a GNSS receiver or a robotic total station mounted on the cart. The line marking device also comprises at least one spray nozzle, for marking a line, which is mounted on the cart and directed towards the ground below the line marking device. The device comprises an interface mounted on the cart for a comparator to compare a detected location by the GNSS receiver to a predetermined pattern. The cart may comprise a motor which is adapted to pivot the steerable wheel towards an intended movement.

EP3400335 A1 discloses a line marking device comprising a GNSS receiver or prism for a robotic total station. The line marking device further comprises at least one spray nozzle and a comparator adapted to compare a detected location to predetermined pattern. The comparator calculates a location and/or a direction error. Further the line marking device comprises a prompting device for providing steering information to a user. The provided information is the location and/or direction error. The at least one spray nozzle and the GNSS receiver or the prism are in a fixed spatial relation to a connecting element, which is connected or connectable to an unmovable receiving element of a cart.

While the technology disclosed in DK 201870263 A1, U.S. Ser. No. 16/632,944, or EP3400335 A1 may be satisfactory in some regards, it has certain drawbacks and limitations, in particular with regard to domain of applicability and efficiency of the marking process.

### SUMMARY

It is, therefore, an object of the present invention to overcome or at least alleviate the shortcomings and disadvantages of the prior art. More particularly, it is an object of the present invention to provide a system for automated, unsupervised marking of a marking area that may improve the efficiency, reliability, and ease of the marking process.

According to a first aspect, the present invention relates to a marking information data element comprising data relating to marking of a marking area configured to be sent to a robot. The marking information data element is understood to comprise all information necessary for the robot to mark the marking area. Thus, it may be tailored according to the input expected by the robot.

The data may comprise map information data of the marking area. The map information data is to be understood to comprise a map of the marking area together with co-ordinates of all locations depicted on the map. For example, these co-ordinates may comprise the latitude and longitude of every location. Alternatively, when these co-ordinates refer to some defined origin, the marking information data element may further comprise co-ordinates of a current location of the robot with respect to the defined origin.

The data may comprise geo-coded two-dimensional images of the marking area. The data may comprise, additionally, elevation information for any of the locations in the marking area.

The geo-code may comprise geographical co-ordinates. As described above, the geographical co-ordinates may comprise the latitude and longitude.

The data may relate to a layout of the markings to be made on the marking area.

The data relating to the layout may comprise a two-dimensional image comprising markings to be made on the marking area. Thus, the robot may process the marking information data element to determine the co-ordinates of locations over which a mark is to be made.

The two-dimensional image may comprise a plurality of pixels, wherein the marking information data element may comprise geo-codes for each of the plurality of pixels. The marking information data element may further comprise color values for each of the pixels, or a Boolean variable indicating whether or not a mark has to be made for each of the pixels. Based on this information, the robot may apply mark, at least a part of, the marking area.

According to a second aspect, the present invention relates to a robot for autonomous marking of a marking area comprising:
a robot communication system that is configured to at least receive a marking information data element from a remote component and
a controlling component that is configured to control the robot based, at least in part, on the marking information data element.

The marking information data element may comprise a marking information data element as described above.

The robot may be configured for marking an outdoor area. The outdoor area may comprise a parking space. Further, the outdoor area may also comprise areas such as runways at airports, harbors, or any other outdoor area that may be marked.

The robot may be configured for marking an indoor area. The indoor area may comprise a parking space, or a warehouse. The indoor areas may comprise other indoor areas that may be marked and this list is to be understood as exemplifying, but not limiting, the present technology.

The robot may further comprise a marking component.

The marking component may be modularly attachable to the robot. Thus, it may be removed if not in use, or if another module is to be installed on the robot as described below.

The marking component may be configured to be movable with respect to other parts of the robot. The marking component may, thus, serve as a moving part the location of which may be controlled precisely. Any marking material dispensers may be installed on the marking component allowing precise control of the marking location.

The marking component may be configured such that a vertical height of the marking component is variable. This may allow changing the width of the marking made. Higher position of the marking component may allow wider (or more spread out) markings to be made. The intensity of the marking may be controlled by controlling the pressure (or rate) at which the marking material is dispensed from a marking material dispenser installed on the marking component.

The marking component may be configured to be movable in a horizontal plane.

The marking component may be configured to be movable along a line in the horizontal plane. This may allow marking significantly parallel to the line in the horizontal plane. By combining with the motion of the robot, and the vertical motion of the marking component as described above, this may allow the marking component to access a plurality of locations in a three-dimensional volume.

The robot may comprise a guide rail to facilitate motion of the marking component. The guide rail may comprise, for example, a movable section comprising rollers that may roll in slots provided for the rollers on the robot. The marking component may then be (removably) attached to this movable section. Note that any of the components of the guide rail may also be removably attached to the robot. For example, the movable section and the slots in which the movable section moves may all comprise part of an assembly that may be detached from the robot, if needed. Or, the slots may be fabricated in the robot itself and only the movable section may be detached. This modularity may allow the robot to be used for a variety of different applications based on the exact module attached to the robot.

The robot may comprise a plurality of guide rails.

The robot may comprise a first guide rail substantially parallel to the line in the horizontal plane described above and configured to facilitate motion of the marking component along the line in the horizontal plane.

The robot may comprise a second guide rail configured to facilitate motion of the marking component in the vertical direction.

The first guide rail may be configured to move over the second guide rail. For example, the movable section as described above may comprise the second guide rail configured to facilitate motion in the vertical direction. The movable section may comprise slots in the horizontal direction over which a movable section of the first guide rail may move. The marking component may then be attached to the movable section of the first guide rail such that vertical motion may be achieved by motion of the movable section of the second guide rail and horizontal motion may be achieved, at least in part, by motion of the movable section of the first guide rail. Additionally, the marking component may be further configured for motion along the movable section of the first guide rail.

The second guide rail may be configured to move over the first guide rail.

The marking component may be further configured to rotate, at least partially, around the guide rail. This may allow for marking angled surfaces such as those of curbs without driving the robot too close to the curb, that may be more complicated.

A maximum extension of the first guide rail may be such that the marking component can mark a region on the side of the robot. For example, as described above, the first guide rail may be moved over the second guide rail such that a part of the first guide rail may extend over a side of the robot. The marking component may then be moved along the first guide rail over the region on the side of the robot.

Any of the guide rails may be removably attached to the robot. As described above, any component of the guide rails may be removably attached so as to allow mounting of different modules on to the robot. For example, one such module may be a marking removal module, that is typically very heavy. In order to mount such a module, it may be of advantage to mount it close to the robot body for stability. Then, the guide rails may be removed and the marking removal module be mounted.

The marking component may be configured to receive a marking material dispenser. The marking component may comprise, for example, a latching mechanism to allow installing the marking material dispenser to be installed on to the marking component. Or, the marking material dispenser may be screwed on to the marking component and appropriate holes may be made in the marking component.

The marking material dispenser may comprise a marking nozzle.

The marking nozzle may be configured to receive a fluid by means of a nozzle inlet.

The marking nozzle may be configured to emit a fluid by means of a nozzle outlet. The fluid may comprise a liquid, such as paint, or a gas, such as air.

The marking nozzle may be modularly attachable to the marking component.

The marking component may further comprise a valve configured to stop fluid flow out of the marking nozzle.

The valve may be located downstream of the nozzle outlet.

The marking component may comprise a plurality of marking nozzles. For example, the plurality of marking nozzles may comprise a marking nozzle for dispensing paint, and a marking nozzle for dispensing air that may be blown over the applied paint to further accelerate drying of the paint. In embodiments, hot air may also be blown over applied paint to improve adhesion of the paint to the surface of the marking area. Or, the plurality of marking nozzles may comprise a plurality of marking material dispensing nozzles. For example, the plurality of marking nozzles may comprise 2 paint dispensing nozzles, that may be configured to paint double lines simultaneously. Any of the plurality of marking nozzles may be individually controlled, i.e., the dispensing of fluid out of any of the marking nozzles may be controlled independently of the dispensing of fluid out of any of the other marking nozzles.

Any of the plurality of marking nozzles may comprise the features described above.

The robot may comprise a marking material reservoir.

The marking material reservoir may comprise a fluid reservoir. The fluid reservoir may hold, for example, paint.

The fluid reservoir may comprise a reservoir outlet configured to allow the fluid to flow out of the fluid reservoir.

The robot may further comprise a conduit configured to allow a fluid to flow through it.

The robot may comprise a pressure pump comprising a pump outlet, wherein the pressure pump may be configured to at least pump fluid out via the pump outlet.

The pressure pump may further comprise a pump inlet and a pump reservoir, wherein the pressure pump may be configured to draw fluid into the pump reservoir via the inlet. As may be appreciated, the pump outlet may be closed when drawing in fluid. A valve may be provided at the pump outlet for this purpose. A valve may also be provided at the pump inlet to prevent fluid from flowing out of the pump inlet when pushing fluid out through the pump outlet.

The pressure pump may be further configured, after drawing fluid into the pump reservoir, to pressurize the fluid to a pumping pressure.

The pumping pressure may be less than 4500 PSI, preferably less than 4000 PSI, further preferably less than 3500 PSI. The pumping pressure may be varied to vary a thickness of the marking applied.

The robot may comprise a first conduit between the reservoir outlet and the pump inlet.

The robot may comprise a second conduit between the pump outlet and the nozzle inlet.

The robot may comprise a plurality of marking material reservoirs.

The robot may be further configured to deliver a mixture of fluids to the marking nozzle.

The marking component may be configured to receive a signal from the controlling component. The controlling component may serve as a control center of the robot. Different signals may be generated and/or sent by the controlling component to control different parts of the robot.

The marking component may be configured to move with respect to other parts of the robot in response to receiving the signal from the controlling component. In particular, this may be understood to comprise movement of guide rails, and/or movable sections thereof.

A result of the motion of the marking component may be a positioning of the marking nozzle over a defined region of the marking area.

The signal may comprise data relating to a displacement of the marking component relative to a current location of the marking component. The data relating to the displacement of the marking component relative to the current location of the marking component may be used, for example, to determine the displacement of any of the guide rails, and/or movable sections thereof, from their current locations and the displacement of the marking component relative to its location on the guide rail. Thus, the movement of the marking component may be broken down into the movement of different components of the robot and may allow for improved precision in movement of the marking component.

The signal may comprise data relating to a vertical displacement of the marking component.

The signal may comprise data relating to a horizontal displacement of the marking component.

The signal may comprise data relating to a displacement of the marking component along the line in the horizontal plane.

The robot may comprise a sensor.

The robot may comprise a plurality of sensors.

The sensor may comprise a camera. The camera may comprise a stereo camera that may be supported by any of a structured laser light projector, ambient light, infrared light, or visible light. The camera may be of advantage in monitoring quality of the markings made by the robot as described further below.

The sensor may comprise a radar assembly configured to aid in the navigation of the robot.

The sensor may comprise a lidar assembly configured to aid in the navigation of the robot.

The sensor may comprise a wireless navigation sensor configured to determine a location of the robot.

The navigation sensor may be configured to determine a location of the robot based on communication with a ground-based network. For example, as described above, the marking information data element may comprise co-ordinates with respect to a defined origin. In this case, the ground-based network may comprise stations with well-defined co-ordinates with respect to the defined origin and the robot may communicate with any of the stations to determine its location.

The navigation sensor may be configured to determine a location of the robot based on communication with a satellite. This may be of advantage, for example, when the geo-code comprises geographical co-ordinates. The navigation sensor may comprise, for example, a global navigation satellite system (GNSS) receiver.

The sensor may comprise an inertial measurement unit configured to measure an orientation of the robot.

The sensor may comprise a speed sensor configured to measure a speed of the robot. Thus, the combination of data from the inertial measurement unit and the speed sensor may be used to determine the velocity of the robot.

The sensor may comprise any of an ultrasonic device, an infrasonic device, a beacon, a magnetic anomaly detector, a MEMS device, or a ground tracking device.

The sensor may comprise a weight sensor configured to measure a weight of the fluid reservoir. The weight may be recorded and may be subsequently used to determine, for example, an efficiency of markings made by the robot. The efficiency may be used to detect issues in and/or improve the performance of the robot. For example, the marking nozzle may get clogged over time that may lead to a lower rate of weight loss from the fluid reservoir. This may suggest clogging of the marking nozzle that may then be corrected. In embodiments, the robot may be equipped with an automatic clog removal process triggered, for example, by rate of weight loss falling below a certain predefined threshold. The automatic clog removal process may comprise, for example, blowing a solvent through the marking nozzle.

The sensor may comprise a humidity sensor. The humidity sensor data may be recorded and used to track the efficiency of the robot, for example. Additionally/alternatively, based on the humidity sensor data, the mode of operation of the robot may be varied. For example, when the ambient humidity is high, air may be blown over fresh markings to accelerate the drying process.

The sensor may comprise a temperature sensor. Temperature sensor data may also be used to improve the marking process. For example, a hotter ambient temperature may lead to faster drying of the marking so that additional blow drying may not be employed.

The sensor may be configured to measure a temperature of a surface of the marking area to be marked. The measurement of surface temperature may also be of advantage in improving the marking process as higher surface temperatures may accelerate the drying of markings.

The sensor may be configured to monitor the ambient brightness. The ambient brightness may be used to assess the reliability of lidar data, for example. Lidar systems may be less reliable when the ambient brightness is high. A weighting scheme for the data collected by any of the sensors may be employed wherein the weights may be proportional to the reliability of a particular sensor. Higher ambient brightness may lower the weight applied to data from the lidar assembly as described above. Additionally, the ambient brightness measurements may be used to switch on/off a beacon that may be provided on the robot.

The robot may comprise a data processing unit.

The data processing unit may be configured to communicate with a sensor of the robot. As described above, the sensor data may all be sent to the data processing unit, where it may be weighted by a factor that may reflect, among other components, a reliability of the sensor, and processed for further use.

The data processing unit may be configured to determine a current configuration of the robot based on the communication with a sensor of the robot. The configuration of the robot may comprise any of a position, orientation, and velocity of the robot. Preferably, the configuration may be determined in geo-code co-ordinates.

The data processing unit may be configured to exchange the marking information data element with the robot communication system. In particular, the data processing unit may be configured to receive the marking information data element from the robot communication system and determine a path for the robot and locations and/or triggers for the marking component at each point of the path based on the marking information data element.

The data processing unit may be further configured to carry out a data quality assessment of the marking information data element. For example, the data processing unit may check the marking information data element for completeness, or ensure that geo-codes for all pixels of the 2D image are provided, among other possible checks.

The data processing unit may be further configured to generate a notification relating to the result of the data quality assessment. For example, if geo-codes for all pixels are not available, or may not be interpolated with a predefined accuracy, a notification may be generated that may comprise, for example, information that a path for the robot could not be successfully generated.

The data processing unit may be further configured to control further operation of the robot based on the result of the data quality assessment. As described in the example above, the notification may alternatively comprise information that a path could be successfully generated and further operation of the robot may then be allowed.

The data processing unit may be configured to generate a path for the robot based on the marking information data element.

The data processing unit may be further configured to determine a control setpoint based on the current configuration of the robot.

The data processing unit may be further configured to determine a control setpoint based on the path generated for the robot. The control setpoint may be used to determine, for example, the translational and/or rotational acceleration of the robot.

The data processing unit may be configured to communicate with the controlling component.

The data processing unit may be configured to send the control setpoint to the controlling component. The controlling component may then determine the signals to be sent to the actuators/motors of, for example, wheels of the robot.

The data processing unit may be configured to determine a marking component setpoint based on the current configuration of the robot.

The data processing unit may be configured to determine a marking component setpoint based on the marking information data element. For example, if the robot is at an end point of a marking, the data processing unit may determine that no further marking material is to be dispensed out of the marking nozzle. Or, a wider line may have to be made further along the path so that a height of the marking component may have to be increased.

The data processing unit may be configured to send the marking component setpoint to the controlling component. As described above, the controlling component may generate the signal sent to the marking component, and/or controlling actuators/motors thereof, based on the marking component setpoint.

The marking component setpoint may comprise data relating to a configuration of the marking component. The configuration may comprise a position of the marking component, and/or an orientation of the marking component around the guide rail as described above, and/or the valve position for the marking nozzle.

The robot according to any of the preceding robot embodiments and with the features of embodiment R67, wherein the controlling component is configured to at least receive data from the data processing unit.

The controlling component may be configured to generate a signal based on the marking component setpoint.

The controlling component may be configured to send the signal to the marking component.

The data processing unit may be further configured to determine the pumping pressure.

The data processing unit may be configured to determine the pumping pressure based on the current configuration of the robot. The pumping pressure may be of advantage in controlling dispensing of the marking material. For example, if the pumping pressure is chosen equal to an ambient pressure, marking material is not dispensed out of the marking nozzle.

The data processing unit may be configured to determine the pumping pressure based on the marking information data element.

The controlling component may be further configured to control an operating pressure of the pressure pump.

The data processing unit may be further configured to send the pumping pressure to the controlling component.

The robot data processing unit may be further configured to generate a notification based on the measured weight of the fluid reservoir. Such notification may be of advantage, for example, when the measured weight falls below a threshold. Based on this check, the robot may be configured to automatically route itself to a refilling station, the co-ordinates of which may also be comprised in the marking information data element. The robot may be configured to allow automatic refilling once the robot is at a refilling station. This may be achieved, for example, by aligning an inlet to the marking material reservoir to an outlet of the refilling station, followed by a closing of the inlet once the measured weight exceeds a predefined threshold.

The data processing unit may be further configured to track the weight of the fluid reservoir over the course of operation of the robot. As described above, this may be of advantage in tracking and/or improving the marking process of the robot.

The robot communication system may be configured to communicate with the remote component by means of a wireless network.

The robot may be configured to access the wireless network by means of a subscriber identity module (SIM) card.

Communication between the robot communication system and the remote component may be mediated by electromagnetic waves ranging in frequency between 1.5 GHZ and 3.5 GHz, preferably between 2 GHz and 3 GHZ, further preferably between 2.4 GHz and 2.8 GHz.

The robot may comprise a body comprising a chassis.

The body may further comprise a housing comprising a plurality of walls. The housing may comprise one or more sections, any of which may be detachable from the chassis. Any of the sections may comprise the plurality of walls.

The plurality of walls may be configured to define an interior space of the robot.

The interior space may be configured to hold the marking material reservoir.

The robot may comprise a plurality of wheels configured to facilitate a motion of the robot, wherein each of the plurality of wheels may be further configured to rotate about an axis of rotation.

The radius of each of the plurality of wheels may be between 15 cm and 80 cm, preferably between 20 cm and 70 cm, further preferably between 30 cm and 60 cm.

The plurality of wheels may comprise 3 wheels.

The plurality of wheels may comprise a first set of wheels comprising a plurality of wheels such that a direction of the axis of rotation of each of the wheels in the first set of wheels is fixed.

The first set of wheels may comprise 2 wheels.

The 2 wheels may be arranged such that the axis of rotation of one wheel is substantially parallel to the axis of rotation of the other wheel.

The 2 wheels in the first set of wheels may be arranged such that the axis of rotation of one wheel coincides with the axis of rotation of the second wheel.

The 2 wheels may be attached to the chassis of the robot.

The plurality of wheels may comprise an omnidirectional wheel configured to facilitate change in the direction of motion of the robot.

The robot according to the preceding embodiment, wherein a direction of the axis of rotation of the omnidirectional wheel is configured to be variable.

The omnidirectional wheel may comprise a swivel castor wheel.

The omnidirectional wheel may be attached close to a back end of the robot.

The first set of wheels may be attached close to a front end of the robot. Preferably, the marking material reservoir may be positioned closer to the front end of the robot than to the back end.

The robot body may comprise a front surface section configured to abut the front end of the robot.

The guide rail may be attached to the front surface section. The forward motion of the robot may thus allow lines to be marked on the sides of the robot, for example, by moving the marking component from one side to the other at each location of the robot. The reverse motion of the robot may allow 2-dimensional images to be marked using the moving marking component.

The front surface section may comprise a hole configured to allow the connection between the pump outlet and the nozzle inlet.

The robot may further comprise a battery configured to supply energy to the robot.

The robot may further comprise a solar panel configured to charge the battery.

The marking component may further comprise a blower outlet configured to let out fluid at high pressure. Alternatively, a cleaner module may be installed on the marking component, wherein the cleaner module may comprise a brush. The marking component may be moved to move the brush, for example, effecting a cleaning of a region of the marking area.

The robot may be further configured to monitor a quality of the markings made on the marking area.

The robot may be configured to monitor the quality of markings based, at least in part, on a measurement made by a sensor. The robot may also be configured to monitor the quality of markings based, at least in part, on a plurality of measurements made by a sensor, or on a plurality of measurements made by a plurality of sensors.

The robot data processing unit may be configured to monitor the quality of markings.

The camera may be configured to capture images of the markings made, wherein the robot may be configured to monitor the quality of the markings based, at least in part, on the images captured by the camera.

The robot may be further configured to re-mark a marking based on the quality of the marking made.

The robot may be configured to detect an existing worn-out marking.

The robot may be further configured to re-mark the existing marking. Thus, it may be understood that the robot may be configured to capture images of the markings made using the camera as described above. These images may be used to improve the marking process, or to detect worn-out or incompletely-made markings. These may be detected by means of any suitable image processing or artificial intelligence algorithm. For example, such an algorithm might detect a plurality of markings in the image and assign a quality score to each of these markings. Based on a predefined threshold of the quality score, the robot may be configured to re-mark some of the markings. The quality score may be stored and later used for assessing the marking process and/or for making improvements to the marking process.

According to a third aspect, the present invention relates to a remote component comprising a remote communication unit, wherein the remote component is configured to communicate, by means of the remote communication unit, with an autonomous robot for marking a marking area.

The remote component may further comprise a remote data processing unit configured to at least send data to the remote communication unit.

The remote data processing unit may be configured to generate a marking information data element.

The remote data processing unit may be further configured to receive marking data, and based thereon, to generate the marking information data element.

The marking data may comprise an image of the marking area.

The marking data may comprise a map of the marking area.

The marking data may comprise a layout of markings to be made on the marking area.

The remote component may further comprise a user interface unit configured to accept input from a user.

The remote data processing unit may be configured to communicate with the user interface unit, wherein the marking data may comprise the user input.

The user input may comprise a layout of markings to be made on the marking area.

The remote component may comprise a display unit configured to communicate with the user interface unit.

The remote data processing unit may be configured to send, at least in part, the marking data to the display unit and prompt for user input based on the part of the marking data.

The remote data processing unit may be configured to send the map of the marking area to the display unit and prompt for user input based on the map of the marking area.

The remote data processing unit may be further configured to assign a geo-code to a pixel on the image of the marking area.

The remote data processing unit may be further configured to assign a geo-code to a location on the map of the marking area.

The remote component may be configured to assess a data quality of the generated marking information data element.

The remote component may be configured to send the marking information data element to the robot based on a result of the data quality assessment.

According to a fourth aspect, the present invention relates to a method for autonomous marking of a marking area, wherein the method comprises: generating a marking information data element based on marking data, sending the marking information data element to a robot, and the robot marking the marking area based on the marking information data element.

The marking information data element may be generated by a remote component.

The robot may comprise a robot as described above.

The remote component may comprise a remote component as described above.

The marking information data element may comprise a marking information data element as described above.

The method may further comprise receiving, at least in part, the marking data. Or, the method may comprise generating, at least in part, the marking data.

The method may comprise providing the part of the marking data to the remote component.

The part of the marking data may be generated by the robot.

According to a fifth aspect, the present invention relates to a system for autonomous marking of a marking area comprising a robot and a remote component, wherein the remote component is configured to generate a marking information data element based on marking data, the remote component is configured to send the marking information data element to the robot, and the robot is configured to mark the marking area based on the marking information data element.

The robot may comprise a robot as described above.

The remote component may comprise the remote component as described above.

The system may be configured to perform the method as described above.

Below, marking information embodiments will be discussed. These embodiments are abbreviated by the letter “I” followed by a number. Whenever reference is herein made to “marking information embodiments”, these embodiments are meant.

I1. A marking information data element comprising data relating to marking of a marking area configured to be sent to a robot.

I2. The marking information data element according to the preceding embodiment, wherein the data comprises map information data of the marking area.

I3. The marking information data element according to the preceding embodiment, wherein the data comprises geo-coded two-dimensional images of the marking area.

I4. The marking information data element according to the preceding embodiment, wherein the geo-code comprises geographical co-ordinates.

I5. The marking information data element according to any of the preceding marking information embodiments, wherein the data relates to a layout of the markings to be made on the marking area.

I6. The marking information data element according to the preceding embodiment, wherein the data relating to the layout comprises a two-dimensional image comprising markings to be made on the marking area.

I7. The marking information data element according to the preceding embodiment and with the features of embodiment I3, wherein the two-dimensional image comprises a plurality of pixels, and wherein the marking information data element comprises geo-codes for each of the plurality of pixels.

I8. The marking information data element according to any of the preceding embodiments, wherein the marking information data element is based on marking data.

Below, robot embodiments will be discussed. These embodiments are abbreviated by the letter “R” followed by a number. Whenever reference is herein made to “robot embodiments”, these embodiments are meant.

R1. A robot for autonomous marking of a marking area comprising:
a robot communication system that is configured to at least receive a marking information data element from a remote component and
a controlling component that is configured to control the robot based, at least in part, on the marking information data element.

R2. The robot according to the preceding embodiment, wherein the marking information data element comprises a marking information data element according to any of the preceding marking information embodiments.

R3. The robot according to any of the 2 preceding embodiments, wherein the robot is configured for marking an outdoor area.

R4. The robot according to the preceding embodiment, wherein the outdoor area comprises a parking space.

R5. The robot according to the any of the preceding robot embodiments, wherein the robot is configured for marking an indoor area.

R6. The robot according to the preceding embodiment, wherein the indoor area comprises a parking space.

R7. The robot according to any of the 2 preceding embodiments, wherein the indoor area comprises a warehouse.

R8. The robot according to any of the preceding robot embodiments, wherein the robot further comprises a marking component.

R9. The robot according to the preceding embodiment, wherein the marking component is modularly attachable to the robot.

R10. The robot according to any of the two preceding embodiments, wherein the marking component is configured to be movable with respect to other parts of the robot.

R11. The robot according to the preceding embodiment, wherein the marking component is configured such that a vertical height of the marking component is variable.

R12. The robot according to any of the 2 preceding embodiments, wherein the marking component is configured to be movable in a horizontal plane.

R13. The robot according to the preceding embodiment, wherein the marking component is configured to be movable along a line in the horizontal plane.

R14. The robot according to any of the preceding robot embodiments and with the features of embodiment R8, wherein the robot comprises a guide rail to facilitate motion of the marking component.

R15. The robot according to the preceding embodiment, wherein the robot comprises a plurality of guide rails.

R16. The robot according to the preceding embodiment and with the features of embodiment R13, wherein the robot comprises a first guide rail substantially parallel to the line in the horizontal plane and configured to facilitate motion of the marking component along the line in the horizontal plane.

R17. The robot according to the preceding embodiment and with the features of embodiment R11, wherein the robot comprises a second guide rail configured to facilitate motion of the marking component in the vertical direction.

R18. The robot according to the preceding embodiment, wherein the first guide rail is configured to move over the second guide rail.

R19. The robot according to the penultimate embodiment, wherein the second guide rail is configured to move over the first guide rail.

R20. The robot according to any of the preceding robot embodiments and with the features of embodiment R14, wherein the marking component is further configured to rotate, at least partially, around the guide rail.

R21. The robot according to any of the preceding robot embodiments and with the features of embodiment R18, wherein a maximum extension of the first guide rail is such that the marking component can mark a region on the side of the robot.

R22. The robot according to any of the preceding robot embodiments and with the features of embodiment R14, wherein the guide rail is removably attached to the robot.

R23. The robot according to any of the preceding robot embodiments and with the features of embodiment R8, wherein the marking component is configured to receive a marking material dispenser.

R24. The robot according to the preceding embodiment, wherein the marking material dispenser comprises a marking nozzle.

R25. The robot according to the preceding embodiment, wherein the marking nozzle is configured to receive a fluid by means of a nozzle inlet.

R26. The robot according to any of the 2 preceding embodiments, wherein the marking nozzle is configured to emit a fluid by means of a nozzle outlet.

R27. The robot according to any of the 3 preceding embodiments, wherein the marking nozzle is modularly attachable to the marking component.

R28. The robot according to any of the 4 preceding embodiments and with the features of embodiment R26, wherein the marking component further comprises a valve configured to stop fluid flow out of the marking nozzle.

R29. The robot according to the preceding embodiment, wherein the valve is located downstream of the outlet.

R30. The robot according to any of the preceding robot embodiments and with the features of embodiment R8, wherein the marking component comprises a plurality of marking nozzles.

R31. The robot according to the preceding embodiment, wherein any of the plurality of marking nozzles comprises the features according to any of the embodiments R25 to R29.

R32. The robot according to any of the preceding robot embodiments, wherein the robot comprises a marking material reservoir.

R33. The robot according to the preceding embodiment, wherein the marking material reservoir comprises a fluid reservoir.

R34. The robot according to the preceding embodiment, wherein the fluid reservoir comprises a reservoir outlet configured to allow the fluid to flow out of the fluid reservoir.

R35. The robot according to any of the preceding robot embodiments, wherein the robot further comprises a conduit configured to allow a fluid to flow through it.

R36. The robot according to any of the preceding robot embodiments, wherein the robot comprises a pressure pump comprising a pump outlet, and wherein the pressure pump is configured to at least pump fluid out via the pump outlet.

R37. The robot according to the preceding embodiment, wherein the pressure pump further comprises a pump inlet and a pump reservoir, and wherein the pressure pump is configured to draw fluid into the pump reservoir via the inlet.

R38. The robot according to the preceding embodiment, wherein the pressure pump is further configured, after drawing fluid into the pump reservoir, to pressurize the fluid to a pumping pressure.

R39. The robot according to the preceding embodiment, wherein the pumping pressure is less than 4500 PSI, preferably less than 4000 PSI, further preferably less than 3500 PSI.

R40. The robot according to any of the 3 preceding embodiments and with the features of embodiments R34, and R35, wherein the robot comprises a first conduit between the reservoir outlet and the pump inlet.

R41. The robot according to any of the preceding robot embodiments and with the features of embodiments R25, R35, and R36, wherein the robot comprises a second conduit between the pump outlet and the nozzle inlet.

R42. The robot according to any of the preceding robot embodiments and with the features of embodiment R33, wherein the robot comprises a plurality of fluid reservoirs.

R43. The robot according to the preceding embodiment and with the features of embodiment R25, wherein the robot is further configured to deliver a mixture of fluids to the marking nozzle.

R44. The robot according to any of the preceding robot embodiments and with the features of embodiment R8, wherein the marking component is configured to receive a signal from the controlling component.

R45. The robot according to the preceding embodiment and with the features of embodiment R10, wherein the marking component is configured to move with respect to other parts of the robot in response to receiving the signal from the controlling component.

R46. The robot according to the preceding embodiment and with the features of embodiment R8, wherein a result of the motion of the marking component is a positioning of the marking nozzle over a defined region of the marking area.

R47. The robot according to any of the 3 preceding embodiments, wherein the signal comprises data relating to a displacement of the marking component relative to a current location of the marking component.

R48. The robot according to the preceding embodiment and with the features of embodiment R11, wherein the signal comprises data relating to a vertical displacement of the marking component.

R49. The robot according to any of the 2 preceding embodiments and with the features of embodiment R12, wherein the signal comprises data relating to a horizontal displacement of the marking component.

R50. The robot according to the preceding embodiment and with the features of embodiment R13, wherein the signal comprises data relating to a displacement of the marking component along the line in the horizontal plane.

R51. The robot according to any of the preceding robot embodiments, wherein the robot comprises a sensor.

R52. The robot according to the preceding embodiment, wherein the robot comprises a plurality of sensors.

R53. The robot according to any of the 2 preceding embodiments, wherein the sensor comprises a camera.

The camera may comprise a stereo camera that may be supported by any of a structured laser light projector, ambient light, infrared light, or visible light.

R54. The robot according to any of the preceding robot embodiments and with the features of embodiment R51, wherein the sensor comprises a radar assembly configured to aid in the navigation of the robot.

R55. The robot according to any of the preceding robot embodiments and with the features of embodiment R51, wherein the sensor comprises a lidar assembly configured to aid in the navigation of the robot.

R56. The robot according to any of the preceding robot embodiments and with the features of embodiment R51, wherein the sensor comprises a wireless navigation sensor configured to determine a location of the robot.

R57. The robot according to the preceding embodiment, wherein the navigation sensor is configured to determine a location of the robot based on communication with a ground-based network.

R58. The robot according to any of the preceding robot embodiments and with the features of embodiment R56, wherein the navigation sensor is configured to determine a location of the robot based on communication with a satellite.

R59. The robot according to any of the preceding robot embodiments and with the features of embodiment R51, wherein the sensor comprises an inertial measurement unit configured to measure an orientation of the robot.

R60. The robot according to any of the preceding robot embodiments and with the features of embodiment R51, wherein the sensor comprises a speed sensor configured to measure a speed of the robot.

R61. The robot according to any of the preceding robot embodiments and with the features of embodiment R51, wherein the sensor comprises any of an ultrasonic device, an infrasonic device, a beacon, a magnetic anomaly detector, a MEMS device, or a ground tracking device.

R62. The robot according to any of the preceding robot embodiments and with the features of embodiments R33, and R51, wherein the sensor comprises a weight sensor configured to measure a weight of the fluid reservoir.

R63. The robot according to any of the preceding robot embodiments and with the features of embodiment R51, wherein the sensor comprises a humidity sensor.

R64. The robot according to any of the preceding robot embodiments and with the features of embodiment R51, wherein the sensor comprises a temperature sensor.

R65. The robot according to any of the preceding robot embodiments and with the features of embodiment R51, wherein the sensor is configured to measure a temperature of a surface of the marking area to be marked.

R66. The robot according to any of the preceding robot embodiments and with the features of embodiment R51, wherein the sensor is configured to monitor the ambient brightness.

R67. The robot according to any of the preceding robot embodiments, wherein the robot comprises a data processing unit.

R68. The robot according to the preceding embodiment and with the features of embodiment R51, wherein the data processing unit is configured to communicate with a sensor of the robot.

R69. The robot according to the preceding embodiment, wherein the data processing unit is configured to determine a current configuration of the robot based on the communication with a sensor of the robot. The configuration of the robot may comprise any of a position, orientation, and velocity of the robot. Preferably, the configuration may be determined in geo-code co-ordinates.

R70. The robot according to any of the 3 preceding embodiments, wherein the data processing unit is configured to exchange the marking information data element with the robot communication system.

R71. The robot according to the preceding embodiment, wherein the data processing unit is further configured to carry out a data quality assessment of the marking information data element.

For example, the data processing unit may check the marking information data element for completeness, or ensure that geo-codes for all pixels of the 2D image are provided, among other possible checks.

R72. The robot according to the preceding embodiment, wherein the data processing unit may be further configured to generate a notification relating to the result of the data quality assessment.

R73. The robot according to any of the 2 preceding embodiments, wherein the data processing unit may be further configured to control further operation of the robot based on the result of the data quality assessment.

R74. The robot according to any of the preceding embodiments and with the features of embodiment R70, wherein the data processing unit is configured to generate a path for the robot based on the marking information data element.

R75. The robot according to any of the preceding robot embodiments and with the features of embodiment R69, wherein the data processing unit is further configured to determine a control setpoint based on the current configuration of the robot.

R76. The robot according to any of the preceding robot embodiments and with the features of the penultimate embodiment, wherein the data processing unit is further configured to determine a control setpoint based on the path generated for the robot.

R77. The robot according to any of the preceding robot embodiments and with the features of embodiment R67, wherein the data processing unit is configured to communicate with the controlling component.

R78. The robot according to the preceding embodiment and with the features of any of embodiments R75, and R76, wherein the data processing unit is configured to send the control setpoint to the controlling component.

R79. The robot according to any of the preceding robot embodiments and with the features of embodiment R69, wherein the data processing unit is configured to determine a marking component setpoint based on the current configuration of the robot.

R80. The robot according to any of the preceding robot embodiments and with the features of embodiment R70, wherein the data processing unit is configured to determine a marking component setpoint based on the marking information data element.

R81. The robot according to any of the 2 preceding embodiments and with the features of embodiment R77, wherein the data processing unit is configured to send the marking component setpoint to the controlling component.

R82. The robot according to any of the 3 preceding embodiments and with the features of embodiment R8, wherein the marking component setpoint comprises data relating to a configuration of the marking component.

R83. The robot according to any of the preceding robot embodiments and with the features of embodiment R67, wherein the controlling component is configured to at least receive data from the data processing unit.

R84. The robot according to any of the preceding robot embodiments and with the features of embodiment R81, wherein the controlling component is configured to generate a signal based on the marking component setpoint.

R85. The robot according to the preceding embodiment and with the features of embodiment R44, wherein the controlling component is configured to send the signal to the marking component.

R86. The robot according to any of the preceding robot embodiments and with the features of embodiments R38, and R67, wherein the data processing unit is further configured to determine the pumping pressure.

R87. The robot according to the preceding embodiment and with the features of embodiment R69, wherein the data processing unit is configured to determine the pumping pressure based on the current configuration of the robot.

R88. The robot according to any of the 2 preceding embodiments and with the features of embodiment R70, wherein the data processing unit is configured to determine the pumping pressure based on the marking information data element.

R89. The robot according to any of the preceding robot embodiments and with the features of embodiment R38, wherein the controlling component is further configured to control an operating pressure of the pressure pump.

R90. The robot according to any of the preceding robot embodiments and with the features of the embodiment R86, wherein the data processing unit is further configured to send the pumping pressure to the controlling component.

R91. The robot according to any of the preceding robot embodiments and with the features of embodiments R62, and R68, wherein the robot data processing unit is further configured to generate a notification based on the measured weight of the fluid reservoir.

R92. The robot according to the preceding embodiment, wherein the data processing unit is further configured to track the weight of the fluid reservoir over the course of operation of the robot.

R93. The robot according to any of the preceding robot embodiments, wherein the robot communication system is configured to communicate with the remote component by means of a wireless network.

R94. The robot according to the preceding embodiment, wherein the robot is configured to access the wireless network by means of a subscriber identity module (SIM) card.

R95. The robot according to any of the 2 preceding embodiments, wherein communication between the robot communication system and the remote component is mediated by electromagnetic waves ranging in frequency between 1.5 GHZ and 3.5 GHZ, preferably between 2 GHz and 3 GHZ, further preferably between 2.4 GHz and 2.8 GHz.

R96. The robot according to any of the preceding robot embodiments, wherein the robot comprises a body comprising a chassis.

R97. The robot according to the preceding embodiment, wherein the body further comprises a housing comprising a plurality of walls.

R98. The robot according to the preceding embodiment, wherein the plurality of walls is configured to define an interior space of the robot.

R99. The robot according to the preceding embodiment and with the features of embodiment R32, wherein the interior space is configured to hold the marking material reservoir.

R100. The robot according to any of the preceding robot embodiments, wherein the robot comprises a plurality of wheels configured to facilitate a motion of the robot, and wherein each of the plurality of wheels is further configured to rotate about an axis of rotation.

R101. The robot according to the preceding embodiment, wherein the radius of each of the plurality of wheels is between 15 cm and 80 cm, preferably between 20 cm and 70 cm, further preferably between 30 cm and 60 cm.

R102. The robot according to any of the 2 preceding embodiments, wherein the plurality of wheels comprises 3 wheels.

R103. The robot according to any of the 2 preceding embodiments, wherein the plurality of wheels comprises a first set of wheels comprising a plurality of wheels such that a direction of the axis of rotation of each of the wheels in the first set of wheels is fixed.

R104. The robot according to the preceding embodiment, wherein the first set of wheels comprises 2 wheels.

R105. The robot according to the preceding embodiment, wherein the 2 wheels are arranged such that the axis of rotation of one wheel is substantially parallel to the axis of rotation of the other wheel.

R106. The robot according to any of the 3 preceding embodiments, wherein the 2 wheels in the first set of wheels are arranged such that the axis of rotation of one wheel coincides with the axis of rotation of the second wheel.

R107. The robot according to any of the 3 preceding embodiments and with the features of embodiment R96, wherein the 2 wheels are attached to the chassis of the robot.

R108. The robot according to any of the preceding robot embodiments and with the features of embodiment R103, wherein the plurality of wheels comprises an omnidirectional wheel configured to facilitate change in the direction of motion of the robot.

R109. The robot according to the preceding embodiment, wherein a direction of the axis of rotation of the omnidirectional wheel is configured to be variable.

R110. The robot according to any of the 2 preceding embodiments, wherein the omnidirectional wheel comprises a swivel castor wheel.

R111. The robot according to any of the preceding robot embodiments and with the features of embodiment R108, wherein the omnidirectional wheel is attached close to a back end of the robot.

R112. The robot according to any of the preceding robot embodiments and with the features of embodiment R103, wherein the first set of wheels is attached close to a front end of the robot.

R113. The robot according to the preceding embodiment and with the features of embodiment R96, wherein the robot body comprises a front surface section configured to abut the front end of the robot.

R114. The robot according to the preceding embodiment and with the features of embodiment R14, wherein the guide rail is attached to the front surface section.

R115. The robot according to any of the 2 preceding embodiments and with the features of embodiment R41, wherein the front surface section comprises a hole configured to allow the connection between the pump outlet and the nozzle inlet.

R116. The robot according to any of the preceding robot embodiments, wherein the robot further comprises a battery configured to supply energy to the robot.

R117. The robot according to the preceding embodiment, wherein the robot further comprises a solar panel configured to charge the battery.

R118. The robot according to any of the preceding robot embodiments and with the features of embodiment R8, wherein the marking component further comprises a blower outlet configured to let out fluid at high pressure.

R119. The robot according to any of the preceding robot embodiments, wherein the robot is further configured to monitor a quality of the markings made on the marking area.

R120. The robot according to the preceding embodiment and with the features of embodiment R51, wherein the robot is configured to monitor the quality of markings based, at least in part, on a measurement made by a sensor.

R121. The robot according to any of the 2 preceding embodiments and with the features of embodiment R67, wherein the robot data processing unit is configured to monitor the quality of markings.

R122. The robot according to any of the 3 preceding embodiments and with the features of embodiment R53, wherein the camera is configured to capture images of the markings made, and wherein the robot is configured to monitor the quality of the markings based, at least in part, on the images captured by the camera.

R123. The robot according to any of the 4 preceding embodiments, wherein the robot is further configured to re-mark a marking based on the quality of the marking made.

R124. The robot according to any of the preceding robot embodiments and with the features of embodiment R53, wherein the robot is configured to detect an existing worn-out marking.

R125. The robot according to the preceding embodiment, wherein the robot is further configured to re-mark the existing marking.

Below remote component embodiments will be discussed. These will be abbreviated by the letter ‘C’ followed by a number.

C1. A remote component comprising a remote communication unit, wherein the remote component is configured to communicate, by means of the remote communication unit, with an autonomous robot for marking a marking area.

C2. The remote component according to the preceding embodiment, wherein the remote component further comprises a remote data processing unit configured to at least send data to the remote communication unit.

C3. The remote component according to the preceding embodiment, wherein the remote data processing unit is configured to generate a marking information data element.

C4. The remote component according to the preceding embodiment, wherein the remote data processing unit is further configured to receive marking data, and based thereon, to generate the marking information data element.

C5. The remote component according to the preceding embodiment, wherein the marking data comprises an image of the marking area.

C6. The remote component according to any of the 2 preceding embodiments, wherein the marking data further comprises a map of the marking area.

C7. The remote component according to any of the 3 preceding embodiments, wherein the marking data comprises a layout of markings to be made on the marking area.

C8. The remote component according to any of the preceding remote component embodiments, wherein the remote component further comprises a user interface unit configured to accept input from a user.

C9. The remote component according to the preceding embodiment and with the features of the embodiment C4, wherein the remote data processing unit is configured to communicate with the user interface unit, and wherein the marking data comprises the user input.

C10. The remote component according to any of the 2 preceding embodiments, wherein the user input comprises a layout of markings to be made on the marking area.

C11. The remote component according to any of the preceding remote component embodiments, wherein the remote component comprises a display unit configured to communicate with the user interface unit.

C12. The remote component according to the preceding embodiment and with the features of embodiments C4, and C9, but without the features of embodiment C7, wherein the remote data processing unit is configured to send, at least in part, the marking data to the display unit and prompt for user input based on the part of the marking data.

C13. The remote component according to the preceding embodiment and with the features of embodiments C6, wherein the remote data processing unit is configured to send the map of the marking area to the display unit and prompt for user input based on the map of the marking area.

C14. The remote component according to any of the preceding remote component embodiments and with the features of embodiment C5, wherein the remote data processing unit is further configured to assign a geo-code to a pixel on the image of the marking area.

C15. The remote component according to any of the preceding remote component embodiments and with the features of embodiment C3, wherein the remote component is configured to assess a data quality of the generated marking information data element.

C16. The remote component according to the preceding embodiment, wherein the remote component is configured to send the marking information data element to the robot based on a result of the data quality assessment.

C17. The remote component according to any of the preceding remote component embodiments, wherein the autonomous robot comprises the robot according to any of the preceding robot embodiments.

R126. The robot according to any of the preceding robot embodiments, wherein the remote component comprises the remote component according to any of the preceding remote component embodiments.

Below method embodiments will be discussed. These are abbreviated by the letter ‘M’ followed by a number. Whenever reference is herein made to method embodiments, these embodiments are meant.

M1. A method for autonomous marking of a marking area, wherein the method comprises:
generating a marking information data element based on marking data,
sending the marking information data element to a robot, and
the robot marking the marking area based on the marking information data element.

M2. The method according to the preceding embodiment, wherein the marking information data element is generated by a remote component.

M3. The method according to any of the 2 preceding embodiments, wherein the robot comprises a robot according to any of the preceding robot embodiments.

M4. The method according to any of the 2 preceding embodiments, wherein the remote component comprises a remote component according to any of the preceding remote component embodiments.

M5. The method according to any of the preceding method embodiments, wherein the marking information data element comprises a marking information data element according to any of the preceding marking information embodiments.

M6. The method according to any of the preceding method embodiments, wherein the method further comprises receiving, at least in part, the marking data.

M7. The method according to the preceding embodiment and with the features of embodiment M2, wherein the method comprises providing the part of the marking data to the remote component.

M8. The method according to any of the preceding method embodiments but without the features of the 2 preceding embodiments, wherein the method further comprises generating, at least in part, the marking data.

M9. The method according to the preceding embodiment, wherein the part of the marking data is generated by the robot.

M10. The method according to any of the preceding method embodiments, wherein the marking data comprises a map/image of the marking area.

M11. The method according to any of the preceding method embodiments, wherein the marking data comprises a layout of markings to be made on the marking area.

Below system embodiments will be discussed. These are abbreviated by the letter ‘S’ followed by a number. Whenever reference is herein made to system embodiments, these embodiments are meant.

S1. A system for autonomous marking of a marking area comprising a robot and a remote component, wherein:
the remote component is configured to generate a marking information data element based on marking data,
the remote component is configured to send the marking information data element to the robot, and
the robot is configured to mark the marking area based on the marking information data element.

S2. The system according to the preceding embodiment, wherein the robot comprises a robot according to any of the preceding robot embodiments.

S3. The system according to any of the 2 preceding embodiments, wherein the remote component comprises the remote component according to any of the preceding remote component embodiments.

S4. The system according to any of the preceding system embodiments, wherein the marking data comprises a map/image of the marking area.

S5. The system according to any of the preceding system embodiments, wherein the marking data comprises a layout of markings to be made on the marking area.

S6. The system according to any of the preceding system embodiments, wherein the system is configured to perform the method according to any of the preceding method embodiments.

### BRIEF DESCRIPTION OF FIGURES

FIG. 1 depicts a system comprising a robot and a remote component;

FIG. 2 depicts the robot in a perspective view;

FIG. 3 depicts data flow between components of the robot; and

FIG. 4 depicts data flow between components of the remote component.

### DETAILED DESCRIPTION OF FIGURES

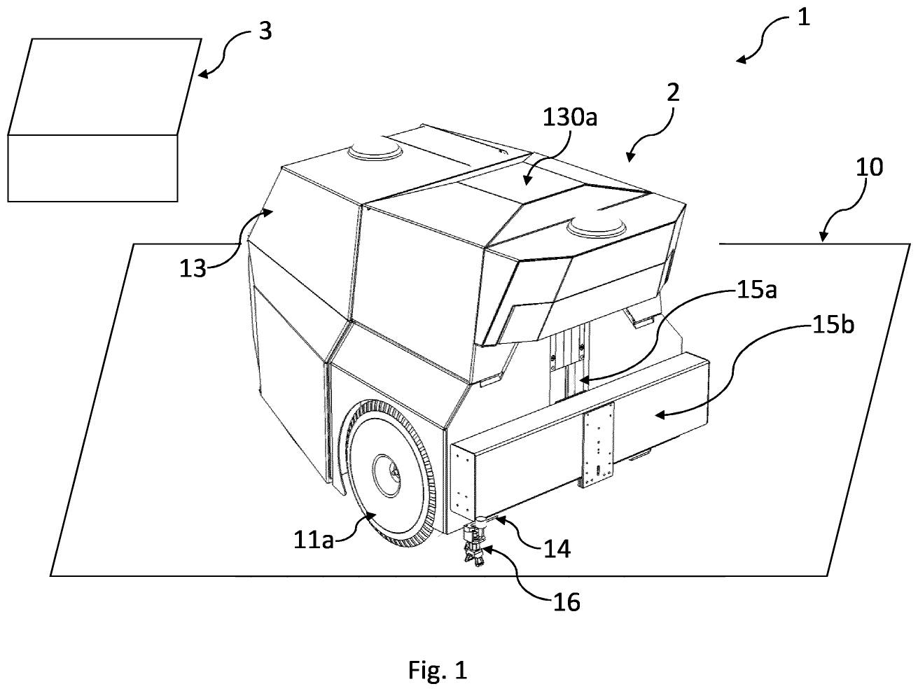

FIG. 1 depicts a system 1 comprising a robot 2 configured for autonomous marking of a marking area 10 and a remote component 3. The remote component 3 may comprise a data processing device such as a tablet, a smartphone, a laptop, a computer, or any other data processing device. The robot 2 and the remote component 3 may be configured to communicate with each other via exchange of a data element. The marking area 10 may comprise an indoor area such as an indoor parking lot, or a warehouse. Alternatively, the marking area 10 may comprise an outdoor area such as an outdoor parking lot, a compound of a factory, or any other similar outdoor area that may be marked. For example, a compound of a factory may comprise markings relating to defined areas for loading/unloading of material. Such markings may be made autonomously by the robot 2. The markings may comprise one-dimensional markings corresponding to markings that may be made by marking line segments, or they may comprise two-dimensional markings.

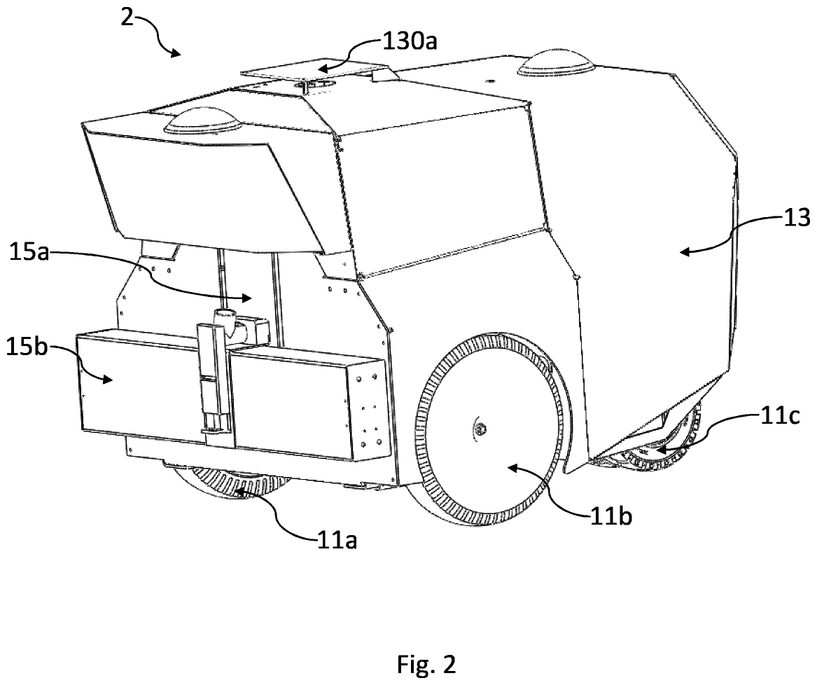

Reference may be made for the following description to FIGS. 1 and 2 that depict further views of the robot 2. The robot 2 comprises a plurality of wheels 11 to enable motion of the robot 2 over the marking area 10. FIG. 1 depicts an example where the plurality of wheels 11 comprises 3 wheels (11a, 11b, 11c). A set of 2 wheels (11a, 11b) may comprise a first set of wheels. These wheels may correspond to front wheels of the robot 2. The front wheels (11a, 11b) may be configured for differential drive, i.e., a rate of rotation of each of the 2 wheels may be controlled independently of the other. This may be achieved by means of independent torques applied to each wheel, for example. A consequence of the differential drive may be that the robot 2 may turn easily. The third wheel 11c may comprise a swivel castor wheel that may further allow for easy maneuvering of the robot 2 and that may correspond to a rear wheel of the robot 2. Further, the swivel castor wheel 11c may be smaller in diameter than the front wheels 11a, 11b. Any of the wheels in the plurality of wheels 11 may have a diameter between 15 cm and 80 cm, preferably between 20 cm and 70 cm, further preferably between 30 cm and 60 cm. As may be appreciated, the number of front or rear wheels may be varied without deviating from the teaching of the present invention.

The robot 2 may further comprise a chassis and a casing/housing 13 to cover the chassis. The casing 13 may comprise a plurality of surface sections 130. The wheels 11 may be attached to the chassis. Components of the robot 2 may be arranged on the chassis and behind/under the casing 13. These components may comprise, for example, a controlling component, a marking material reservoir, and other components as will be described further below.

The topmost surface section 130a of the casing 13 may have a maximum height between 60 cm and 180 cm, preferably between 75 cm and 160 cm, further preferably between 85 cm and 140 cm. A length of the robot 2 (corresponding to the direction defined by the front and rear wheels 11 of the robot 2) may be between 0.75 m and 2.0 m, preferably between 1.0 m and 1.8 m, further preferably between 1.2 m and 1.6 m. A breadth of the robot 2 may be between 0.5 m and 1.5 m, preferably between 0.75 m and 1.25 m, further preferably between 0.8 m and 1.1 m.

The robot 2 further comprises a marking component 14. The marking component 14 is configured for marking the marking area 10. The marking component 14 may be comprised in a linear module of the robot 2. The linear module may further comprise a guide rail 15, in this example a plurality of guide rails 15 (15a, 15b), that facilitate motion of the marking component 14 relative to other parts of the robot 2. Guide rail 15a comprises a vertical guide rail that allows the marking component 14 to move in a vertical direction. Guide rail 15b comprises a horizontal guide rail that allows the marking component to move in a horizontal direction. In the depicted example, guide rail 15b is further configured to move over guide rail 15a. Thus, the marking component 14 may move over the guide rail 15b in order to change position in the horizontal direction, whereas vertical motion may be achieved by motion of the guide rail 15b (together with the marking component 14) over the guide rail 15a. Motion in the vertical direction may be of advantage in controlling a width of the marking made by the marking component 14.

Further, while in the depicted example guide rail 15b is configured to move over guide rail 15a, in embodiments, any one of the guide rails may be configured to move over any of the other guide rails. Thus, by moving the robot 2 and motion along the guide rails 15 the marking component 14 may be positioned at substantially any point in the three-dimensional cube bounded above and below by the dimensions of the robot 2. A vertical extension of the marking component 14 may be between 5 cm and 50 cm, preferably between 10 cm and 40 cm, further preferably between 15 cm and 30 cm. A horizontal extension of the marking component 14 may be between 100 cm and 300 cm, preferably between 120 cm and 200 cm, further preferably between 140 cm and 160 cm.

Any of the components of the linear module comprising the marking component 14 and the guide rail(s) 15 may be removably attached to the robot 2. This may be of advantage in allowing a plurality of different functionalities to be associated with the robot 2. For example, the linear module may be removed and a marking material removing module be attached in place of the linear module. Typically, the marking material removing module is much heavier than the marking module (linear module) as described above. Thus, it may have to be placed appropriately so as to not affect the stability of the robot 2. This placement may only be possible by a removal of the linear module.

The marking component 14 may be configured to receive a marking material dispenser 16. The marking material dispenser 16 may be configured to dispense marking material for marking the marking area 10. The marking material may comprise a fluid such as paint. In FIG. 1, the marking material dispenser comprises a fluid dispenser comprising a marking nozzle.

However, in embodiments, the marking material may comprise a marking tape and an appropriate marking material dispenser 16 may be employed. The marking component 14 may be configured to receive a marking material dispenser 16. The marking component 14 may be further configured to move only in the horizontal direction along the guide rail 15b and motion along the guide rail 15a may be restricted or completely stopped. This may be achieved by means of electronic control of the motion of the marking component 14 or by other mechanical means. The marking material dispenser 16 may comprise a marking tape dispenser, for example. For dispensing of the marking tape, for example, the with the marking material dispenser may comprise a marking tape roll. The marking material dispenser 16 may then comprise a slit through which the marking tape may be dispensed on to the marking area 10. Means for cutting the marking tape may also be provided in the marking material dispenser 16.

For a fluid marking material, such as paint, the marking material dispenser 16 comprising marking nozzle may be employed. A conduit, one end of which may be connected to the marking nozzle, may also be present on the robot 2. The other end of conduit may be connected to a pressure pump that may be installed on the robot 2. The pressure pump may be configured to pump fluid out of a fluid reservoir, also installed in the robot 2, and into the conduit. The pressure pump may pressurize the fluid to pump it into the conduit and further out of the marking nozzle. The pressure may be less than 4500 PSI, preferably less than 4000 PSI, further preferably less than 3500 PSI. A maximum flow rate out of the marking nozzle 161 may be between 1 L/min and 6 L/min, preferably between 1.25 L/min and 5.5 L/min, further preferably between 1.5 L/min and 5 L/min. A diameter of the marking nozzle outlet may be less than 0.5 mm, preferably less than 0.4 mm, further preferably less than 0.3 mm.

In embodiments, the marking robot 2 may be further configured to allow a mixture of fluids to be used for the markings. The mixture of fluids may be contained in the marking material reservoir. In yet further embodiments, the marking material may comprise thermoplastics or cold plastic.

The marking component 14 may further comprise a blower outlet. Thus, the marking component may comprise a plurality of nozzles, comprising, exemplarily, the blower outlet and the marking material dispenser nozzle. The blower outlet may be configured to let out fluid at high pressure. The high-pressure fluid may be of advantage in cleaning up a region of the marking area 10 on which a marking is to be made. The fluid dispensed by the blower outlet may comprise, for example, air. Further, the blower outlet may also be configured to deliver hot air. This may be of advantage in removing moisture from the marking area 10 prior to application of the marking. Alternatively, the marking component 14 may be configured to heat the marking area 10 by other means, such as infrared light. The heating means may also be of advantage in heating up a marking made with marking tape that may allow for improved adhesion of the marking tape to the marking area 10.

The marking component 14 may further be fitted with a solid dispenser 16. The solid dispenser 16 may be used to dispense glass beads or sand onto the marking area 10. Suitable reservoirs may also be provided in the robot 2 for any of these materials. Heat mechanisms as described above may also be used to heat up the surface post application of glass beads. In general, as may be appreciated, a number of materials may be used for marking and appropriate dispensers 16 for such materials may be installed on the marking component 14.

As described above, the marking component 14 may be configured to receive such dispensers, for example, via screws or latching mechanics. The robot 2 may also be appropriately configured to hold reservoirs for any of these materials and for supplying these materials from their reservoirs to their dispensers 16. For example, instead of installing a reservoir for each possible material, the robot 2 may be configured such that reservoirs may be changed by lifting the casing 13. Preferably, the reservoir may be located close to the front side of the robot 2. This may provide greater stability and may improve the efficiency of pumping from the reservoir to the marking material dispenser 16. In general, it may be thus understood that depending on the choice of the marking material, such as cold plastic, fluid, or solid, an appropriate marking material dispenser 16 may be installed on to the marking component 14 and the marking component 14 may be configured to receive any of these marking material dispensers.

The robot 2 may be equipped with a weight sensor configured to determine a weight of the reservoir. The weight sensor may be used to track the amount of marking material remaining that may be of advantage in ensuring that the robot 2 does not run out of marking material (for example, by ensuring that the robot 2 may approach a refilling station for automatic refilling as described above) as well as in tracking the efficiency of the robot 2 vis-à-vis the amount of marking material used.

The marking component 14 may be further configured for rotation about the guide rail 15b. This may allow the robot 2 to mark marking areas 10 such as curbs without having to be specially navigated. The robot 2 may also be configured for marking two-dimensional images as described above. For this, the robot 2 may be configured to move in a reverse direction such that the rear wheel 11c is further ahead along the direction of motion than the front wheels 11a, 11b. Thus, in general, the robot 2 may be configured to move both in a forward and in a reverse direction.

The robot 2 may be further configured to house a source of energy, such as a battery. The capacity of the battery may be between 1 kWh and 5 kWh, preferably between 1.5 kWh and 4.5 kWh, further preferably between 2 kWh and 4 kWh. Larger capacity of the battery may allow the robot 2 to apply markings for a longer duration at the cost of larger weight. In embodiments, the battery may comprise a plurality of batteries, such as 2 batteries. The battery may be charged by means of external energy supply. Or, a solar charging mechanism may be provided in the robot 2 to charge the battery. This may comprise, among other things, a solar panel (or any other solar energy conversion system) located on a top surface section of the housing 13. This may be of advantage when the robot 2 is used to mark outdoor marking areas 10.

The robot 2 may be configured to carry out autonomous marking of the marking area 10 based on a marking information data element 20, that is itself based on marking data, received from the remote component 3. The marking information data element 20 may comprise an image/map of the marking area 10 along with a layout of the markings to be made on the marking area 10. In embodiments, the robot 2 may be further configured to map the marking area 10 and generate a map of the marking area 10. Further, the robot 2 may also be configured to house a drone using which aerial images of the marking area 10 may be captured and used for generating the marking data. Generally, it may be understood that a map or image of the marking area 10 and the layout of the desired marking to be made on the marking area 10 comprise the marking data. The marking data may then be used to generate the marking information data element 20.

The map/image of the marking area 10 comprises geo-codes of locations depicted on the map/image. Geo-codes may comprise the geographical co-ordinates of locations that may comprise, for example, latitudes and longitudes. Alternatively, for indoor areas where latitudes and longitudes are difficult to obtain, the geo-codes may comprise co-ordinates with respect to some defined origin. For example, the robot 2 may map out such indoor marking area 10 by using its displacement to track co-ordinates of all the points with respect to, for example, a starting position of the robot 2. In such a scenario, the map of the area may then be sent to the remote component 3 where the desired layout may be superimposed on the map. Once the layout has been superimposed, the marking data (comprising the map together with the layout) may then be used to generate the marking information data element 20. The marking information data element 20 is then sent back to the robot 2. In particular, the marking information data element 20 may then comprise data relating to the layout that may specify the co-ordinates of points over which a marking has to be made.

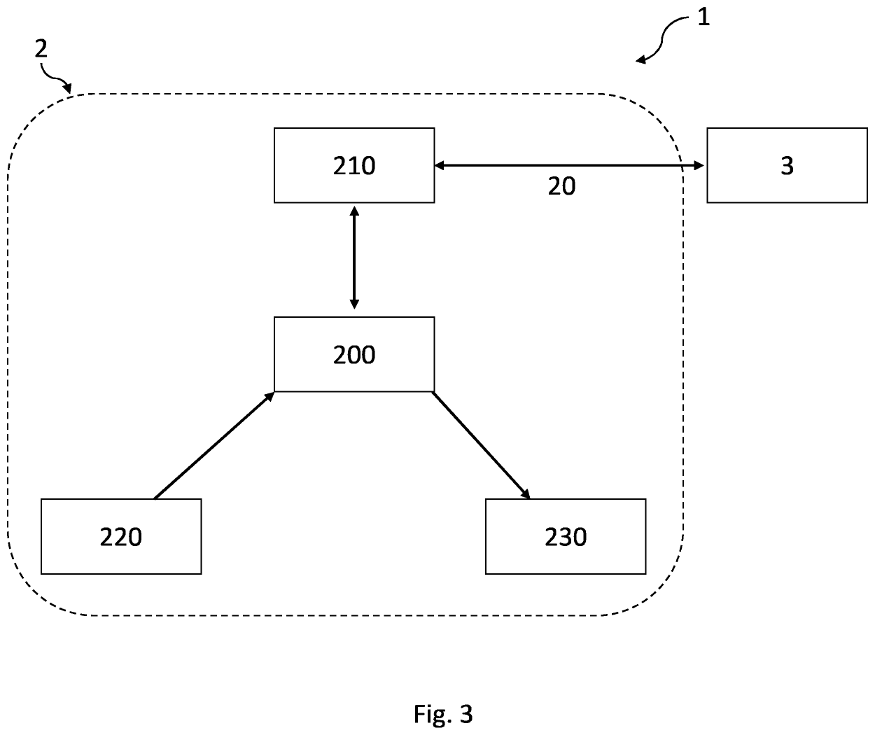

FIG. 3 depicts an exemplary embodiment of data flow between different components of the system 1, and particularly components of the robot 2, in order to carry out autonomous marking of the marking area 10. As described above, the robot 2 is configured to communicate with the remote component 3. The communication with the remote component 3 may be achieved by means of a robot communication system 210 installed in the robot 2. The robot communication system 210 may be configured to communicate with the remote component 3 by means of a hard wired or wireless network. Preferably, the robot 2 may communicate with the remote component 3 by means of a subscriber identity module (SIM) card. However, any appropriate means of wireless exchange such as Wifi, Bluetooth, analog signals, or other methods may be used.

A relevant consideration when choosing a particular means of communication may be the fidelity and/or speed of data transfer as typically an image of the marking area 10 along with the desired layout may be transferred from the remote component 3 to the robot 2. Depending on the rate of transfer, it may be impractical to use a certain method for the transfer. However, some methods may be hindered in indoor marking areas 10 and so another suitable method may be chosen. Preferably, the robot 2, and particularly the robot communication system 210 thereof, may be configured to choose an appropriate means of communication based on checking of a predefined criterion. Wirelessly, the robot communication system 210 may be configured to communicate with the remote component 3 by means of electromagnetic radiation with a frequency between 1.5 GHZ and 3.5 GHZ, preferably between 2 GHz and 3 GHZ, further preferably between 2.4 GHz and 2.8 GHz.

The robot 2 may further comprise a robot data processing unit 200. The robot data processing unit 200 may be configured for data processing tasks within the robot 2. More particularly, the robot data processing unit 200 may communicate with the robot communication system. The robot data processing unit 200 may be configured to receive the marking information data element 20 from the robot communication system 210 and to perform a quality assessment of the marking information data element 20. Such an assessment may comprise, for example, assessing the marking information data element 20 for completeness of geo-code data such that the layout can be made. This may be achieved by any image-processing method and may comprise, for example, checking if a geo-code is available for every location (to within a certain radius) on the layout. Or, other appropriate checks may be carried out.

Based on a result of such a check, a notification may be sent by the robot data processing unit 200 to the robot communication system 210 which may then forward it to the remote component 3. The notification may comprise, for example, a notification of incomplete data and complete data may then be provided again to the robot 2. Alternatively, if the marking information data element 20 is determined to be complete, the robot data processing unit 200 may proceed further with the marking process.

The robot data processing unit 200 may be further configured to generate a path (or waypoints) for the robot 2 based on the marking information data element 20. For example, such a path may comprise the geo-code of a starting location of the robot 2 and subsequent waypoints that may lead to marking of the layout on the marking area 10. Thus, the robot 2 may comprise an, at least substantially, autonomous robot.

The robot 2 may comprise a plurality of sensors 220 to aid in the marking process. The robot data processing unit 200 may be configured to at least receive data from any of these sensors 220. Based on the data received from any of the sensors 220, the robot data processing unit 200 may be configured to determine a current configuration of the robot 2. The configuration of the robot 2 may comprise any of a position, orientation and velocity of the robot 2. Preferably, the configuration may be determined in geo-code co-ordinates. The robot data processing unit 200 may be further configured to apply a weight to the measurement from any of the plurality of sensors 220 based on a reliability of the measurement.

The plurality of sensors 220 may comprise any of a stereo camera supported by any of a structured laser light projector, ambient light, infrared light or visible light, a radar assembly, a lidar assembly, a wireless navigation sensor that may be configured to communicate with any of a ground-based or satellite-based network, an inertial measurement unit, a speed sensor, an ultrasonic device, an infrasonic device, a beacon, a magnetic anomaly detector, a MEMS device, or a ground tracking device. The camera and the inertial measurement unit may be of particular advantage in determining the configuration of the robot 2 in an indoor marking area 10. The navigation sensor, on the other hand, may be of particular advantage in outdoor marking areas 10.

A plurality of other sensors 220 may also be housed on the robot 2 to improve the marking process. These may comprise a humidity sensor that may be configured to measure an ambient humidity and/or the moisture of the surface of the marking area 10. Based on the measured surface moisture, for example, the robot 2 may be configured to blow air on to the marking area 10 before marking it. Similarly, a composition of the marking material may be varied based on the ambient humidity. The robot 2 may further comprise a temperature sensor configured to determine a temperature of the surface of the marking area 10 and/or the ambient temperature. The robot 2 may further comprise a sensor to monitor the ambient brightness. The ambient brightness may be relevant, for example, to assign weight to the measurement from a sensor. For example, when the ambient brightness is low, a larger weight may be assigned to the measurement from an infrared camera than that from a visible light camera.

Based on the current configuration, and the relative location of the next waypoint, a set of control points may be generated by the robot data processing unit 200. These may be sent to a controlling component 230 of the robot 2 and may comprise data relating to, for example, a torque to be applied on the wheels 11 of the robot 2 to achieve a desired acceleration of the robot 2.

The controlling component 230 may be configured to generate signals for any actuators, for example, that may cause a motion of different components of the robot 2. More particularly, it may be configured to control a motion of any of the wheels 11 of the robot 2 as well as that of the marking component 14. The signals may be generated based on set points received from the robot data processing unit 200. The robot data processing unit 200 may be further configured to generate a marking component setpoint based on the marking information data element 20 and the current configuration of the robot 2. For example, the robot data processing unit 200 may determine a thickness of the marking to be made (that may be varied by changing a height of the marking component 14) and a two-dimensional location on the marking area 10 over which the marking has to be made. This information may be sent to the controlling component 230 that may then cause a motion of the marking component 14 to enable the appropriate marking to be made.

The robot 2 may be further configured for re-marking of the marking area 10, i.e., it may be employed to mark a marking area 10 over which markings have been made earlier but that have become worn-out. This may be achieved by means of images from a camera on the robot 2. The robot data processing unit 200 may be configured to detect such worn-out markings in images of the marking area 10 captured by the camera and to re-mark such areas. The corresponding layout may be obtained from the remote component 3. The camera may also be used to capture images of the marking area 10 after the robot 2 has finished marking it. Based on the images captured after the marking, the robot 2, and particularly the robot data processing unit 200 thereof, may be configured to determine a quality of the markings made.

The quality may be determined, for example, by means of an artificial intelligence algorithm or a suitable image processing algorithm. Alternatively, the robot 2 may be further configured to send the images to the remote component 3, the remote component 3 may display the images to a user, and the remote component 3 may be configured to allow user input for the quality of markings displayed in the image. The robot 2 may be configured to store the results of the quality assessment for markings and to use the results of the quality assessment for further changes to the marking process. For example, the robot 2 may be used to paint a line. Then, such an assessment may be used to calibrate a model for the height of the marking component 14 (and thus, the marking material dispenser 16) and/or the operating pressure of the pressure pump to achieve a desired thickness of the line.

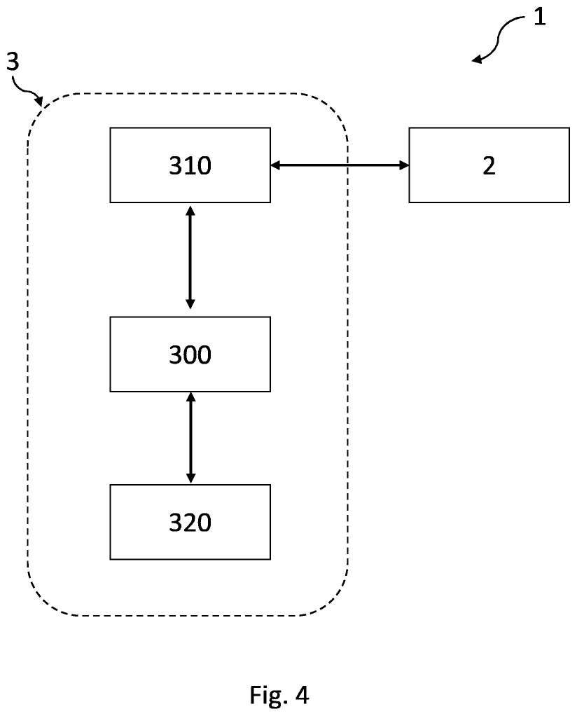

FIG. 4 depicts an exemplary embodiment for the data flow inside the remote component 3. The remote component 3 may comprise a remote communication unit 310, a remote data processing unit 300 and a user interface unit 320. The remote communication unit 310 may be configured for communication with the robot 2, and particularly a robot communication system 210 thereof. The remote communication unit 310 may be configured to send the marking information data element 20 to the robot 2. The remote communication unit 310 may be configured to receive a result of a data quality assessment of the marking information data element 20 from the robot communication system 210. The remote communication unit 310 may be further configured to communicate with the remote data processing unit 300. In particular, the remote communication unit 310 may be configured to receive the marking information data element 20 from the remote data processing unit 300. The remote communication unit 310 may also be configured to forward the result of the data quality assessment of the marking information data element 20 to the remote data processing unit 300.

The remote data processing unit 300 may be configured to generate the marking information data element 20 from marking data. Generating the marking information data element 20 may comprise starting from a map/image of the marking area 10. As described above, this map/image may be provided to the remote component 3 by the robot 2. Or, it may be provided to the remote data processing unit 300 as an input, and the remote data processing unit 300 may be configured for accepting the map/image as an input. The remote data processing unit 300 may be configured to check for geo-code data corresponding to the image. If geo-code data is not available for a location, the remote data processing unit 300 may be configured to assign geo-codes of the locations on the image. A map may already comprise geo-codes for all locations depicted on the map. The final map/image that is comprised in the marking data, and subsequently used to generate the marking information data element 20, may thus comprise geo-codes for all depicted locations.

The remote data processing unit 300 may further accept a layout of markings to be made on the marking area 10. These may be provided to the remote data processing unit 300 as input. Or, the remote data processing unit 300 may further communicate with a user interface unit 320. The user interface unit 320 may be configured for obtaining the desired layout from a user of the system 1. For example, the user interface unit 320 may comprise a touchscreen and the user may be prompted to draw the desired layout on the map. Alternatively, the user may upload the image of the desired layout on the map to the user interface unit 320. Generally, it may be understood that the user interface unit 320 is configured to obtain the desired layout on the map of the marking area 10. Note that the order of generating geo-codes and obtaining a layout may not be strictly as described here. For example, the layout may be obtained first and geo-codes generated after.

The remote data processing unit 300 may further carry out a data quality assessment of the generated marking information data element 20 before sending it to the robot 2. As described above, the data quality assessment may comprise, for example, a data completeness check or any other suitable checks. Based on the result of the data quality assessment, the remote data processing unit 300 may send the marking information data element 20 to the remote communication unit 310 for forwarding to the robot 2.

Overall, embodiments of the present technology are thus directed to a system and method for autonomous marking of a marking area that may lead to improved efficiency, reliability, and ease of the marking process.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, preferred embodiments have been described with reference to the accompanying drawings, the skilled person will understand that these embodiments were provided for illustrative purpose only and should by no means be construed to limit the scope of the present invention, which is defined by the claims.

1-15. (canceled)

16. A robot for autonomous marking of a marking area comprising:
a robot communication system that is configured to at least receive a marking information data element from a remote component; and
a controlling component that is configured to control the robot based, at least in part, on the marking information data element.

17. The robot according to claim 16, wherein the robot comprises a marking component, wherein the marking component is configured to be movable with respect to other parts of the robot, and wherein the robot comprises a guide rail to facilitate motion of the marking component.

18. The robot according to claim 17, wherein the marking component is configured such that a vertical height of the marking component is variable, wherein the marking component is configured to be movable in a horizontal plane, and wherein the marking component is configured to be movable along a line in the horizontal plane.

19. The robot according to claim 18, wherein the robot comprises a plurality of guide rails, and wherein the robot comprises a first guide rail substantially parallel to the line in the horizontal plane and configured to facilitate motion of the marking component along the line in the horizontal plane.

20. The robot according to claim 19, wherein the robot comprises a second guide rail configured to facilitate motion of the marking component in a vertical direction.

21. The robot according to claim 20, wherein the first guide rail is configured to move over the second guide rail.

22. The robot according to claim 17, wherein the robot comprises a plurality of guide rails.

23. The robot according to claim 17, wherein the marking component comprises a plurality of marking nozzles.

24. The robot according to claim 23, wherein the robot comprises a marking material reservoir, wherein the marking material reservoir comprises a fluid reservoir, wherein the robot comprises a plurality of fluid reservoirs, and wherein the robot is further configured to deliver a mixture of fluids to the plurality of marking nozzles.

25. The robot according to claim 16, wherein the robot comprises a sensor, and wherein the robot is configured to monitor a quality of markings based, at least in part, on a measurement made by the sensor.

26. The robot according to claim 25, wherein the sensor comprises a camera configured to capture images of the markings made, and wherein the robot is configured to monitor the quality of the markings based, at least in part, on the images captured by the camera.

27. The robot according to claim 26, wherein the robot is further configured to re-mark a marking based on the quality of the marking made.

28. The robot according to claim 16, wherein the robot comprises a sensor, and wherein the sensor comprises a lidar assembly configured to aid in navigation of the robot.

29. The robot according to claim 16, wherein the robot comprises a data processing unit, wherein the data processing unit is configured to exchange the marking information data element with the robot communication system, and wherein the data processing unit is configured to generate a path for the robot based on the marking information data element.

30. A remote component comprising a remote communication unit, wherein the remote component is configured to communicate, by means of the remote communication unit, with an autonomous robot according to claim 16 for marking a marking area.

31. The remote component according to claim 30, wherein the remote component further comprises a remote data processing unit configured to at least send data to the remote communication unit, wherein the remote data processing unit is configured to generate the marking information data element.

32. The remote component according to claim 30, wherein the remote component further comprises a user interface unit configured to accept input from a user, wherein the user input comprises a layout of markings to be made on the marking area.

33. A system for autonomous marking of a marking area comprising a robot according to claim 16 and a remote component comprising a remote communication unit, wherein the remote component is configured to communicate, by means of the remote communication unit, with the robot for making a marking area, wherein:
the remote component is configured to generate a marking information data element based on marking data;
the remote component is configured to send the marking information data element to the robot; and
the robot is configured to mark the marking area based on the marking information data element.

34. The system according to claim 33, wherein the marking data comprises a map or image of the marking area and a layout of markings to be made on the marking area.

35. A method for autonomous marking of a marking area, wherein the method comprises:
generating a marking information data element based on marking data;
sending the marking information data element to a robot; and
the robot marking the marking area based on the marking information data element.
